(19) United States
(12) Patent Application Publication
(10) Pub. No.: US 2026/0110392 A1
(43) Pub. Date: Apr. 23, 2026

(54) MASS RADIO CHARGING RACK AND ASSOCIATED SYSTEMS AND APPARATUSES

(71) Applicant: Weavix, Inc., Wichita, KS (US)

(72) Inventors: Kevin F. WYER, Sedgwick, KS (US); Kevin TURPIN, Wichita, KS (US)

(21) Appl. No.: 18/923,342

(22) Filed: Oct. 22, 2024

(51) Int. Cl. F16M 11/22; F16M 11/10; H02J 7/00

(52) U.S. Cl. CPC F16M 11/22; F16M 11/10; H02J 7/731

(57) ABSTRACT

Systems and apparatuses for mass charging of radio devices are disclosed. The disclosed technology provides a charging rack system configured to house multiple charging docks, where each charging dock is configured to house multiple radio devices. The charging rack system is comprised of one or more modules that includes one or more foldable/collapsible shelves fixed to a rigid frame via multiple support brackets. The foldable shelves include a vertical section (e.g., an upward-facing lip) perpendicular to a top surface of each of the shelves configured to wall-in and/or help secure the charging docks on the shelves. In some embodiments, the charging rack system is comprised of multiple modules stacked upon each other and coupled via multiple connector brackets.

### TECHNICAL FIELD

The present disclosure is generally related to mass charging rack systems for wireless radio devices.

### BACKGROUND

Frontline workers often rely on radios to enable them to communicate with their team members. Whether in emergency services, construction, or other industries, the ability to instantly relay information, coordinate actions, and request assistance is vital. The importance of maintaining reliably operable radios becomes more pronounced as the size of a frontline team grows (e.g., requiring more coordination between disparate groups), as the risk of the work increases (e.g., risking potential loss of equipment and/or personnel), and if time is of the essence (e.g., requiring rapid communication with few or no disruptions), to name a few. Furthermore, the challenge of maintaining reliably operable radios grows as the number of radios needed by the team increases. For example, maintaining accountability of a large network of radios is challenging, particularly if different teams or groups of team members need to interchange/exchange radios in the field, or if various shifts of workers rely on the same network of radios throughout the workday. As another example, accommodating space for the storage and charging of a large network of radios can prove challenging, particularly in many frontline work environments where space and access to wall outlets is limited or unavailable.

### BRIEF DESCRIPTION OF THE DRAWINGS

FIG. 1 is a drawing illustrating an example apparatus for device communication and tracking, in accordance with one or more embodiments.

FIG. 2 is a drawing illustrating an example charging dock for apparatuses implementing device communication and tracking, in accordance with one or more embodiments.

FIG. 3A is a perspective view of a charging rack system with first and second modules stacked, in accordance with one or more embodiments.

FIG. 3B is a front view of the charging rack system of FIG. 3A.

FIG. 3C is a top-down view of the charging rack system of FIG. 3A.

FIG. 3D is a side view of the charging rack system of FIG. 3A.

FIG. 4A is a front view of a first module of a charging rack system, in accordance with one or more embodiments.

FIG. 4B is a side view of the first module of FIG. 4A.

FIG. 5A is a front view of a second module of a charging rack system, in accordance with one or more embodiments.

FIG. 5B is a side view of the second module of FIG. 5A.

FIGS. 6A and 6B are side views of first and second vertical beams of first and second modules with multiple connector brackets, in accordance with one or more embodiments.

FIGS. 7A-7C are various perspective views of a joint connecting parts of a foldable shelf, in accordance with one or more embodiments.

FIG. 8 is a side view of a cable tray, in accordance with one or more embodiments.

FIG. 9 is a perspective view of a support bracket, in accordance with one or more embodiments.

FIG. 10A is a side view of a mounting bracket on a module, in accordance with one or more embodiments.

FIG. 10B is a perspective view of a mounting bracket, in accordance with one or more embodiments.

### DETAILED DESCRIPTION

Systems and apparatuses for mass charging of radio devices are disclosed. For example, the disclosed technology provides a charging rack system (also referred to as a “charging system”) configured to house multiple charging docks, where each charging dock is configured to house multiple radio devices. The charging rack system is comprised of at least one module that includes one or more foldable/collapsible shelves fixed to a rigid frame via multiple support brackets. The foldable shelves include a vertical section (e.g., an upward-facing lip) perpendicular to a top surface of each of the shelves configured to wall-in and/or help secure the charging docks on the shelves.

In some embodiments, the charging rack system is comprised of multiple modules stacked upon each other and coupled via multiple connector brackets. In some embodiments, the charging rack system includes multiple cable trays attached to the rigid frame to help guide cables (e.g., power cables/cords, ethernet cabling, etc.). In some embodiments, the charging rack system includes one or more outlet strips and one or more magnetic strip lights coupled to the frame. The frame is configured to receive the outlet strips and strip lights in various configurations/positions to accommodate various configurations of the stackable modules, foldable shelves, and charging docks. In some embodiments, the charging rack system is mountable to a wall via multiple mounting brackets. In some embodiments the charging rack system includes a rolling base, allowing the charging rack system to be easily positioned/repositioned and mobilized in a variety of work environments.

The benefits and advantages of the disclosed technology include providing a sturdy, adaptable, charging system capable of accommodating a wide range of work environments and scalable for a variety of radio network needs. For example, the multiple stackable modules allow the charging rack system to adapt to the shifting needs of a frontline environment, including the ability to accommodate more or fewer radios over time or between different work environments, the ability to adapt to more or less available space for storage/charging of radios, and the ability to easily transport the charging system by unstacking and transporting the modules individually, and folding/collapsing the shelves to reduce the burden on cargo space.

Mobile radio devices (e.g., smart radios) can be used to communicate between various workers. As the responsibilities of these workers adapt with technology, however, the functionality of mobile radio devices must evolve to provide additional functionality. For example, mobile radio devices have been improved to increase connectivity in previously disconnected locations. Moreover, improvements in mobile radio devices enable workers to communicate through additional forms of communication, often without user intervention. Mobile radio devices also provide a mechanism for tracking workers and equipment on a worksite to improve safety and efficiency. Mobile radio devices can further track details about employees during their work shift, and that information can be used to analyze the employees’ strengths and weaknesses. Accordingly, the present disclosure relates to improvements in mobile radio devices. In general, improvements are directed to one of four technical aspects (“pillars”): network connectivity, collaboration, location services, and data, which are explained below.

Network connectivity: Smart radios operate using multiple onboard radios and connect to a set of known networks. This pillar refers to radio selection (e.g., use of multiple onboard radios in various contexts) and network selection (e.g., selecting which network to connect to from available networks in various contexts). These decisions may depend on data obtained from other pillars; however, inventions directed to the connectivity pillar have outputs that relate to improvements to network or radio communications/selections.

Collaboration: This pillar relates to communication between users. A collaboration platform includes chat channel selection, audio transcription and interpretation, sentiment analysis, and workflow improvements. The associated smart radio devices further include interface features that improve ease of communication through reduction in button presses and hands-free information delivery. Inventions in this pillar relate to improvements or gained efficiencies in communicating between users and/or the platform itself.

Location services: This pillar refers to various means of identifying the location of devices and people. There are straightforward or primary means, such as the Global Positioning System (GPS), accelerometer, or cellular triangulation. However, there are also secondary means by which known locations (via primary means) are used to derive the location of other unknown devices. For example, a set of smart radio devices with known locations are used to triangulate other devices or equipment. Further location services inventions relate to identification of the behavior of human users of the devices, e.g., micromotions of the device indicate that it is being worn, whereas lack of motion indicates that the device has been placed on a surface. Inventions in this pillar relate to the identification of the physical location of objects or workers.

Data: This pillar relates to the “Internet of Workers” platform. Each of the other pillars leads to the collection of data. Implementation of that data into models provides valuable insights that illustrate a given worksite to users who are not physically present at that worksite. Such insights include productivity of workers, experience of workers, and accident or hazard mapping. Inventions in the data pillar relate to deriving insight or conclusions from one or more sources of data collected from any available sensor in the worksite.

Embodiments of the present disclosure will now be described with reference to the following figures. Although illustrated and described with respect to specific examples, embodiments of the present disclosure can be embodied in many different forms and should not be construed as limited to the embodiments set forth herein. Accordingly, the examples set forth herein are non-limiting examples referenced to improve the description of the present technology.

### Portable Wireless Apparatus

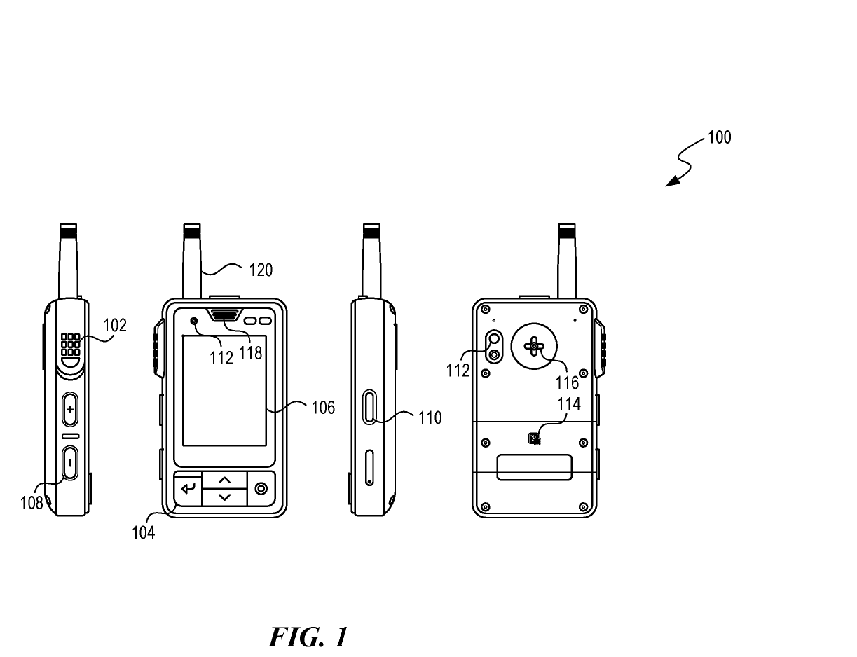

FIG. 1 is a drawing illustrating an example apparatus 100 for device communication and tracking, in accordance with one or more embodiments. The apparatus 100 (also referred to as “radio device,” “smart radio,” or “radio”) includes a user interface that includes a PTT button 102, a 4-button user input system 104, a display 106, an easy to grab volume control 108, and a power button 110. The PTT button 102 can be used to control the transmission of data from or the reception of data by the apparatus 100. For example, the apparatus 100 may transmit audio data or other data when the PTT button 102 is pressed and receive audio data or other data when the PTT button 102 is released. In other examples, the PTT button 102 may control the transmission of audio data or other data from the apparatus 100 (e.g., transmit when the PTT button 102 is pressed), though apparatus 100 may transmit and receive audio data or other data at the same time (e.g., full duplex communication). The 4-button user input system 104 can be used to interact with the apparatus 100. For example, the 4-button user input system 104 can be used as a 4-direction input system (e.g., up-down-left-right), a 2-directional-enter-back (e.g., up-down-enter-back), or any other button configuration. The display 106 can output relevant visual information to the user. In aspects, the display 106 can enable touch input by the user to control the apparatus 100. The volume control 108 can control the loudness of the apparatus 100. The power button 110 can turn the apparatus 100 on and off.

The apparatus 100 further includes at least one camera 112, an NFC tag 114, a mount 116, at least one speaker 118, and at least one antenna 120. The camera 112 can be implemented as a front camera capturing the environment in front of the display 106 or a back camera capturing the environment opposite the display 106. The NFC tag 114 can be used to connect or register the apparatus 100. For example, the NFC tag 114 can register the apparatus 100 as being docked in a charging dock. In yet another example, the NFC tag can connect to a workers badge to associate the apparatus with the worker. The mount 116 can be used to attach the apparatus 100 to the worker (e.g., on a utility belt of the worker). The speaker 118 can output audio received by or presented on the apparatus 100. The volume of the speaker 118 can be controlled by the volume control 108. The antenna 120 can be used to transmit data from the apparatus 100 or receive data at the apparatus 100. In some cases, transmission or reception by the antenna 120 can be controlled by the PTT button 102 or another button of the user interface.

### Charging Dock

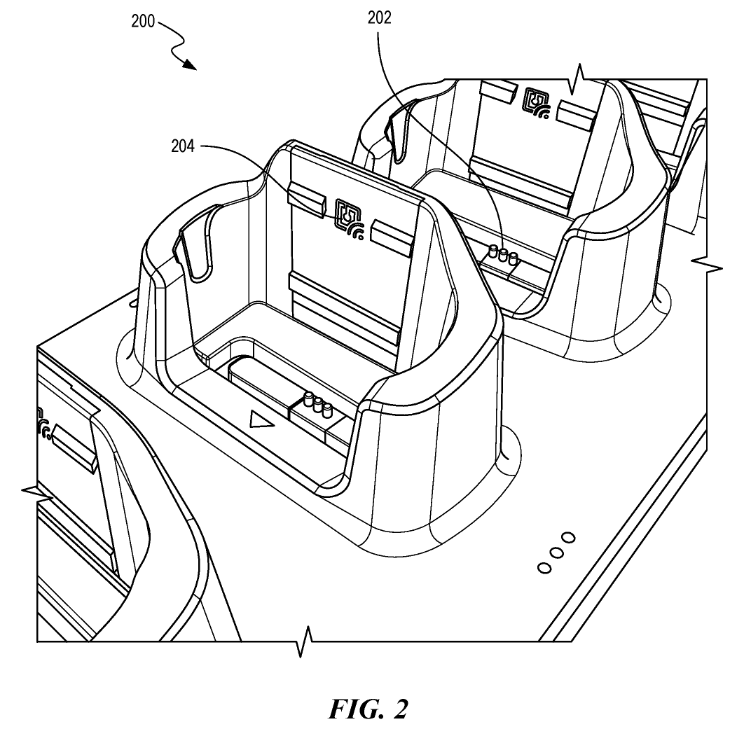

FIG. 2 is a drawing illustrating an example charging dock 200 for apparatuses implementing device communication and tracking, in accordance with one or more embodiments. The charging dock 200 can be used to dock one or more mobile radio devices for charging. In aspects, power can be supplied to the mobile radio devices docked at the charging dock 200 through charging pins 202 located in each receptacle of the charging dock 200. The charging pins 202 can be inserted into a charging port of the mobile radio devices. A worker clocking out at a facility can place a mobile radio device into the charging dock 200. The mobile radio device can remain docked until it is removed from the charging dock 200 by a worker clocking in at the facility.

The charging dock 200 or the mobile radio device can determine when the mobile radio device has been docked in the charging dock 200. For example, each receptacle of the charging dock 200 can have an NFC pad 204 that connects with the mobile radio device when the mobile radio device is docked in that receptacle of the charging dock 200. Alternatively or additionally, the mobile radio device can be determined to be docked in the charging dock 200 when the charging pins 202 of a receptacle are inserted into the mobile radio device. In these ways, a cloud computing system can be made aware of the location and status (e.g., docked or removed) of the mobile radio device through communication with the charging dock 200 or the mobile radio device.

### Mass Charging System for Radio Devices

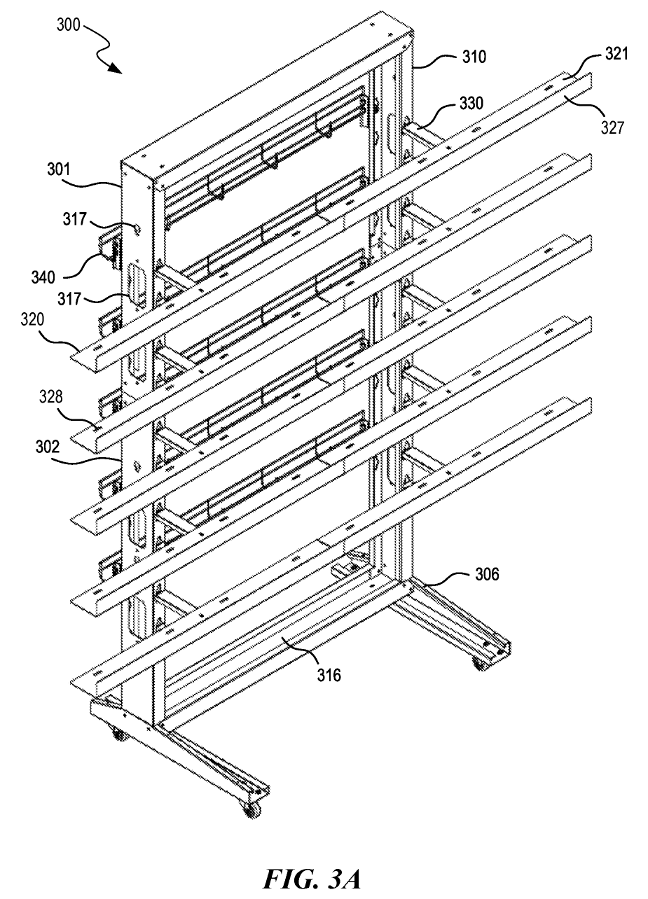

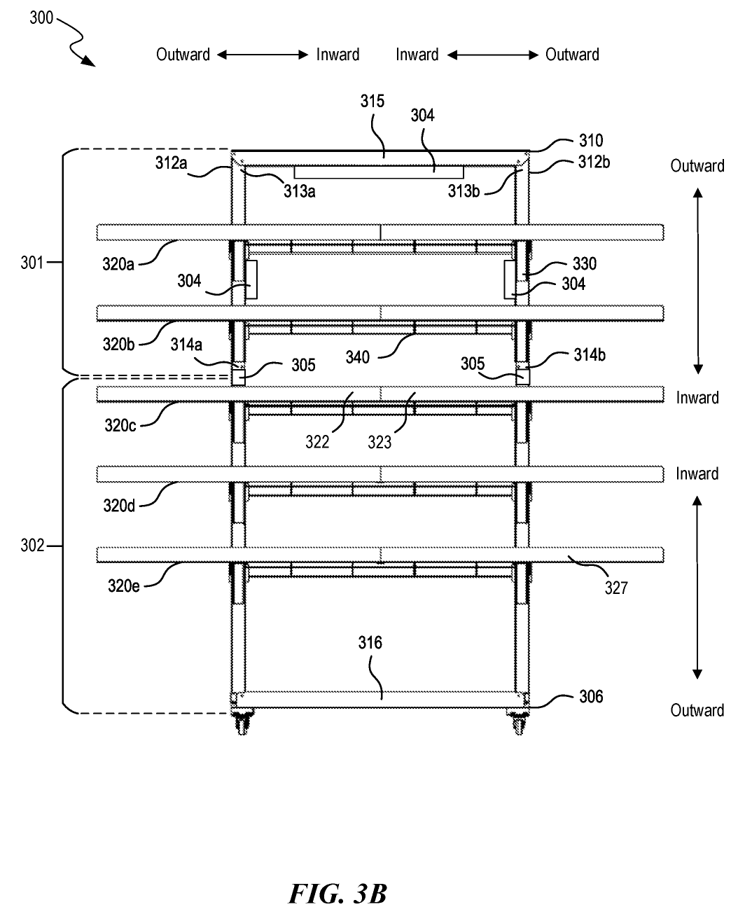

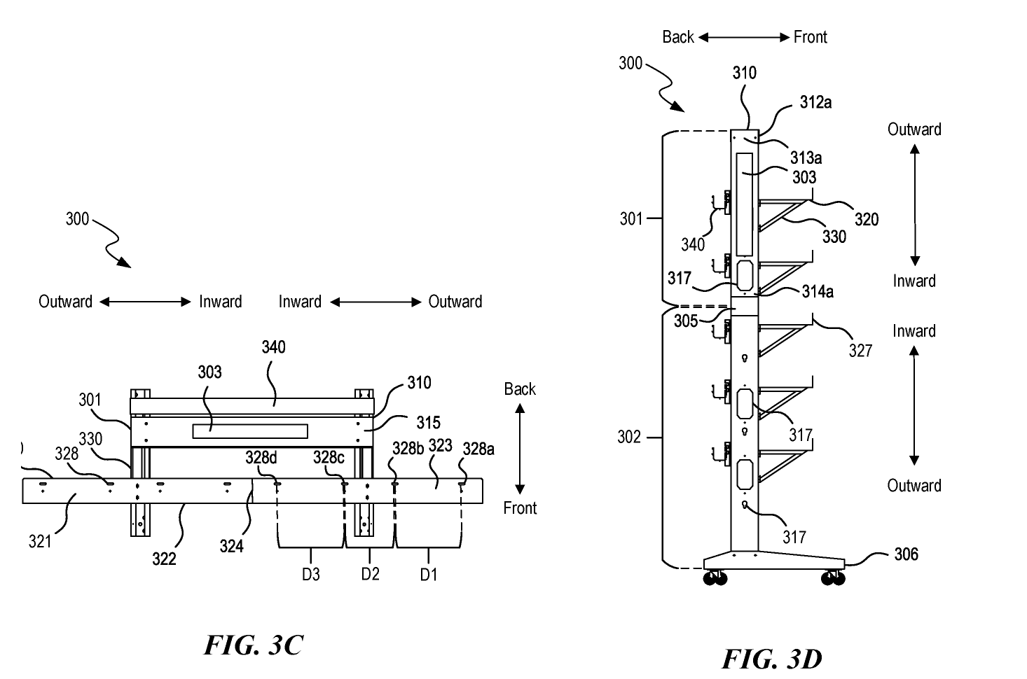

FIG. 3A is a perspective view of a charging rack system 300 with a first module 301 stacked upon a second module 302, in accordance with one or more embodiments. FIG. 3B is a front view of the charging rack system 300. FIG. 3C is a top-down view of the charging rack system 300. FIG. 3D is a side view of the charging rack system 300. Referring to FIGS. 3A–3D together, the charging rack system 300 is configured to provide a dynamic storage, housing, and charging solution for multiple charging docks (e.g., the charging docks 200 of FIG. 2) simultaneously. Each charging dock is configured to charge and/or house multiple radio devices (e.g., the portable wireless apparatuses 100 of FIG. 1, and/or traditional/legacy radio devices, to name a few examples).

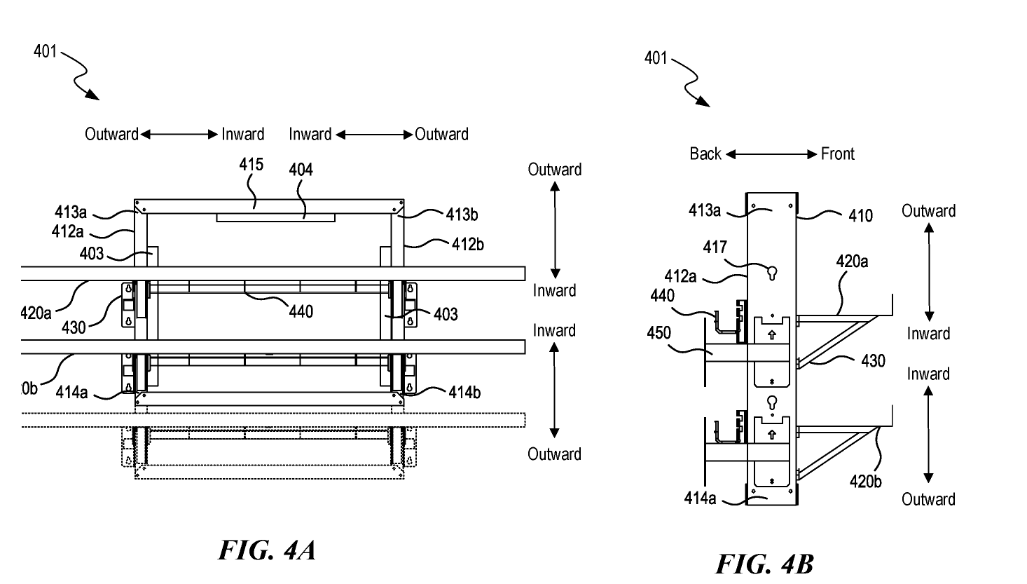

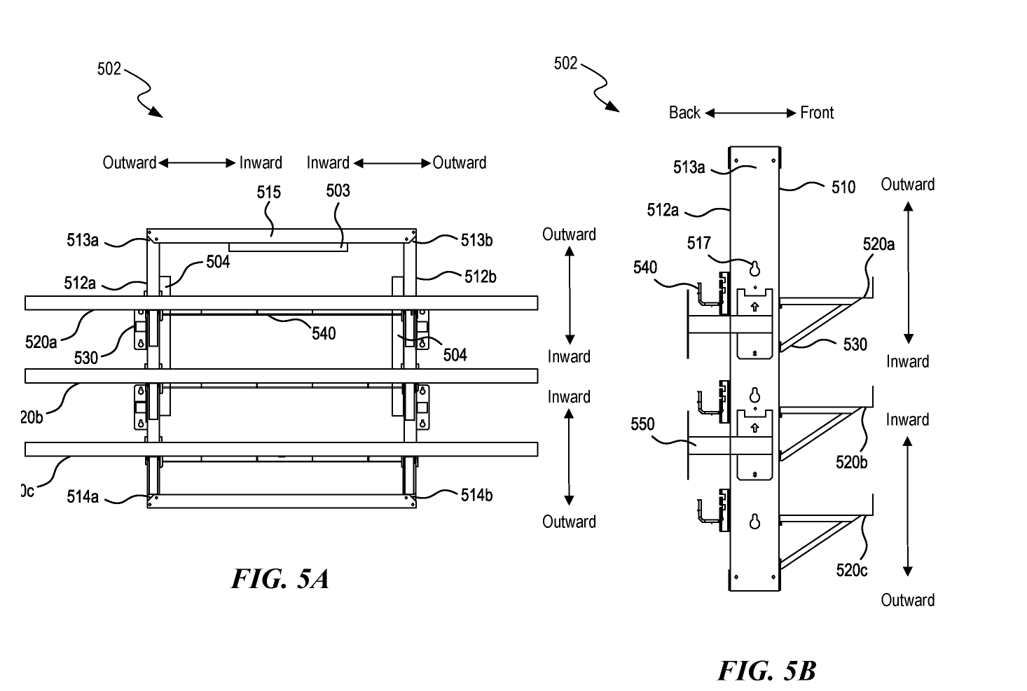

In the present example, the charging rack system 300 is comprised of a first module 301 stacked upon a second module 302 (discussed individually in an unstacked configuration in FIGS. 4A–5B). Each module 301, 302 is configured to receive multiple charging docks, as described further herein. Taking the first module 301 as an example configuration, the first module 301 includes a rigid frame 310 (also referred to as an outer support structure) comprised of two vertical beams 312a, 312b, and a horizontal beam 315 (also referred to as bars). The vertical beams 312a, 312b and horizontal beam 315 are configured to provide structural integrity to the frame 310 and to provide coupling locations (e.g., surfaces) for one or more foldable/collapsible shelves 320, one or more support brackets 330, and one or more additional components (e.g., one or more each of: outlet strips 303, strip lights 304, connector brackets 305, a rolling base 306, cable trays 340, and mounting brackets (not pictured), each of which is discussed further herein). Each of the vertical beams 312a, 312b includes a top end 313a, 313b, and a bottom end 314a, 314b, opposite the top end. The horizontal beam 315 is configured to connect the vertical beams 312a, 312b together. In some embodiments, the horizontal beam 315 connects the vertical beams 312a, 312b together via the top ends 313a, 313b of the respective vertical beams 312a, 312b. In some embodiments, the rigid frame 310 includes a bottom horizontal beam 316 and a top horizontal beam (e.g., horizontal beam 315). The bottom horizontal beam 316 is configured to connect vertical beams 312a, 312b together via bottom ends 314a, 314b of the respective vertical beams 312a, 312b. In some embodiments, the bottom horizontal beam 316 provides coupling locations for the rolling base 306. In some embodiments, the rigid frame 310 comprises additional horizontal beams (not shown) connecting the vertical beams 312a, 312b, to provide further structural integrity and coupling locations to the frame 310.

In some embodiments, the first module 301 and the second module 302 have different heights relative to ground. That is, when unstacked, the height of the first module 301 is different from the height of the second module 302. In some embodiments, the height of the first module 301 is less than the height of the second module 302. This design ensures that the second module 302 serves as a stable base for the first module 301 when in a stacked configuration, making it suitable for environments where stability is crucial, such as in data centers or communication hubs. This design also provides customizability of the size and capacity (with regard to number of charging docks accommodated) of the charging rack system 300. For example, a user can determine that due to space constraints and the need for only a limited number of radio devices/charging docks, only the first module 301 will be deployed. In other examples, only the second module 302 is deployed.

Each of the first and second vertical beams 312a ,312b includes multiple pre-positioned structures 317 between their top ends 313a, 313b, and bottom ends 314a, 314b. These structures 317 are specifically designed to facilitate the secure and detachable coupling of the first module 301 to the second module 302 (e.g., via the connector bracket 305) when stacked, as well as the support brackets 330, cable trays 340, and mounting brackets to the frame 310. The pre-positioned structures 317 include a variety of sizes, positions, and configurations to enhance the modularity and flexibility of the charging rack system 300. In some embodiments, the pre-positioned structures 317 are positioned on one or more surfaces of the frame 310 of the first and/or second modules 301, 302. In the present example, the multiple pre-positioned structures 317 are positioned on an outward-facing (with respect to a longitudinal centerline of the modules 301, 302) surface of the frame 310, a front-facing surface, and a back-facing surface. The structures 317 on the outward-facing surface are configured to detachably couple the first module 301 to the second module 302, as well as the mounting brackets to the frame 310. The structures 317 on the front-facing surface are configured to detachably couple the support brackets 330 to the frame 310. The structures 317 on the back-facing surface are configured to detachably couple the cable trays 340 to the frame 310. In some embodiments, one or more outlet strips 303 and/or strip lights 304 are configured detachably couple to frame 310 via one or more of the structures 317. In some embodiments multiple of the pre-positioned structures 317 are holes and/or orifices configured to receive a fixation element (e.g., a bolt, screw, bracket connector, key for a key/slot mechanism, etc.). In some embodiments multiple of the structures 317 are one or more of notches, recesses, indentations, and grooves.

In some embodiments, one or more surfaces of the frame 310 (e.g., outward-facing surfaces, front-facing surface, back-facing surface, inward-facing surfaces, downward-facing surfaces, etc.) are configured to simultaneously couple (e.g., via one or more structures 317) at least one outlet strip 303 and at least one strip light 304. For example, an inward-facing surface of the horizontal beam 315 can be configured to couple to the strip lights 304, and inward facing surfaces of the first and second vertical beams 312a, 312b can be configured to couple to separate sets of outlet strips 303.

In some embodiments, the outlet strips 303 and strip lights 304 are configured to simultaneously couple to the frame 310 so as not to interfere with the operability of each other. For example one or more strip lights 304 can be configured to be positioned on one or more inward-facing surfaces of the vertical beams 312a, 312b, and horizontal beam 315 while at least one outlet strip 303 is positioned on one or more outward-facing surfaces of vertical beams 312a, 312b, and horizontal beam 315. In another example, one or more strip lights 304 can be configured to be positioned on an inward-facing surface of the horizontal beam 315 while at least one outlet strip 303 is positioned on one or more inward-facing surfaces of the vertical beams 312a, 312b. In a further example, the one or more strip lights 304 can be positioned on one or more inward-facing surfaces of the vertical beams 312a, 312b when one or more outlet strips 303 are positioned on an inward-facing surface of the horizontal beam 315.

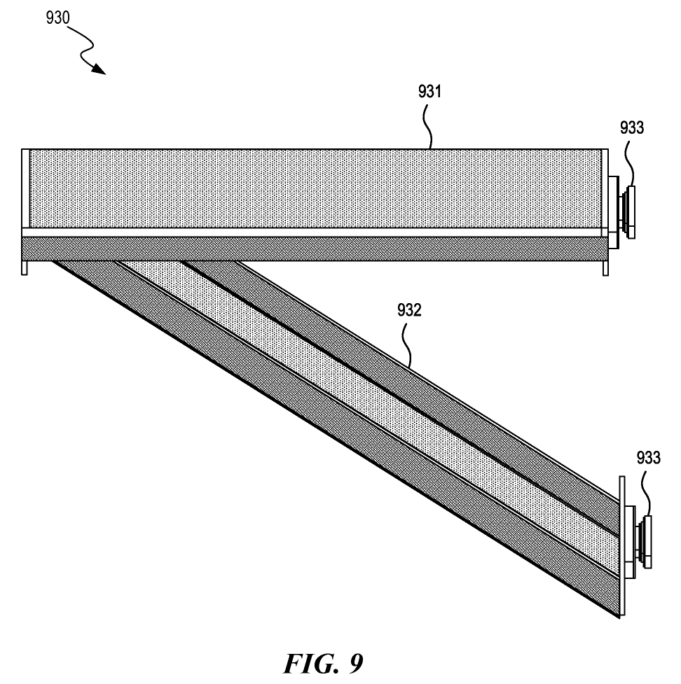

The first and second modules 301, 302 each include one or more foldable/collapsible shelves 320 configured to receive multiple charging docks and/or provide a flat surface 321 upon which the charging docks are positioned. In the present example, first module 301 includes two foldable shelves 320a–b, each of which includes a corresponding flat surface 321 upon which multiple charging docks can be positioned. The second module 302 includes three foldable shelves 320c–e, each of which also includes a corresponding flat surface 321. In some embodiments, the foldable shelves 320a–e are spaced approximately equally in a vertical direction with respect to ground on their respective module 301, 302. In some embodiments, the foldable shelves 320a–e are coupled to their respective module 301, 302 via multiple support brackets 330. Each of the support brackets 330 is configured to detachable couple to one of the first and second vertical beams 312a, 312b, as discussed further herein with reference to FIG. 9.

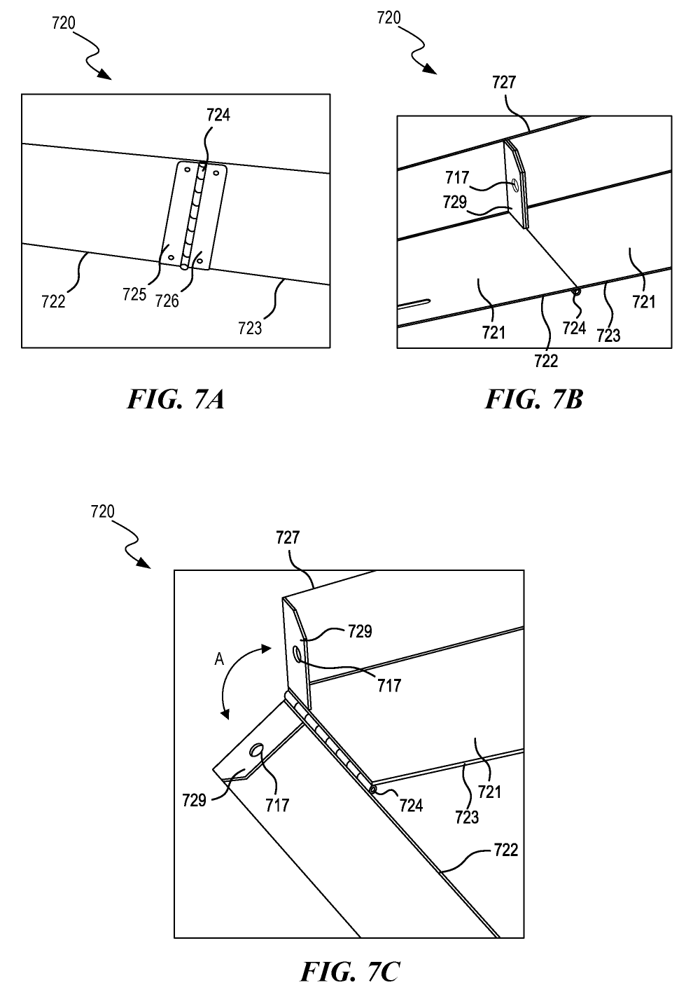

In some embodiments, each foldable shelf 320a–e is comprised of a corresponding two sections (e.g., a first section 322 and a second section 323) coupled together such that the two sections 322, 323 fold one on top of the other lengthwise. That is, the two sections are coupled via a corresponding joint 324 (discussed further with reference to FIGS. 7A-7C ) such that the first and second sections 322, 323 have an axis of rotation about the joint 324, and such that when the first and second sections 322, 323 are unfolded, a continuous flat surface (e.g., flat surface 321) is formed across a boundary that adjoins the two sections 322, 323. In some embodiments, the first section 322 includes a first coupling element and the second section 323 includes a second coupling element. The first and second coupling elements are configured to couple the first and second sections 322, 323 to each other via the joint 324 (discussed further herein, with reference to FIGS. 7A-7C). The joint 324 is configured to couple the first and second coupling elements together. In some embodiments, the joint 324 has an axis of rotation about which the first and second sections 322, 323 are foldable only in a single direction. In some embodiments, each of the foldable shelves 320a–e has an unfolded length greater than the width of the frame 310.

In some embodiments, each foldable shelf 320a–e includes a corresponding vertical section 327 that is perpendicular to the corresponding flat surface 321. The vertical section 327 is positioned along the long edge of the foldable shelf 320a–e, specifically the long edge that is distant relative to the frame 310. The vertical section 327 creates a lip or brim that projects upward relative to the ground, helping to secure or wall-in charging docks positioned on the foldable shelves 320a–e. In some embodiments, the height of the vertical section 327 is greater than the height of the charging docks positioned on the foldable shelf 320a–e.

Each of the first and second sections 322, 323 of the foldable shelves 320a–e includes multiple elongated slots 328 designed to attach the charging docks securely. These slots span the length of each section 322, 323 and are strategically spaced to optimize the attachment and organization of the charging docks. The slots are arranged such that there is a first distance D1 between a first slot 328a and a second slot 328b, followed by a second distance D2 between the second slot 328b and a third slot 328c, followed by a third distance D3 between the third slot 328c and a fourth slot 328d, etc., for a given number of slots on a given foldable shelf 320a–e. In some embodiments, the first and third distances D1, D3, are approximately equal, ensuring uniform spacing. In some embodiments, the second distance D2 is less than the first distance D1. The variation in the distances D1–D3 between the various slots 328 is designed to accommodate different sizes or types of charging docks. In some embodiments, each of the first and second sections 322, 323 is configured to attach at least two charging docks.

In some embodiments, the charging rack system 300 includes a rolling base 306 designed to enhance the mobility and flexibility of the system 300. The rolling base 306 is configured to detachably couple to the bottom ends of the first and second vertical beams (e.g., the bottom ends 314a, 314b of vertical beams 312a, 312b of the first module 301, and/or corresponding components of the second module 302), providing a stable and mobile foundation for the entire system 300 when modules 301, 302 are stacked (or alternatively the individual module to which the base 306 is attached if unstacked). The rolling base includes multiple casters and features at least one irregularly-shaped surface configured to provide structural support and/or coupling locations for the vertical beams 312a, 312b. The irregular shape may include contours, ridges, or other features that improve the grip and stability of the rolling base on various surfaces. In some embodiments, the irregular shape is configured to help distribute the weight of the system more evenly, reducing the risk of tipping or instability.

FIG. 4A is a front view of a first module 401 of a charging rack system, in accordance with one or more embodiments. FIG. 4B is a side view of the first module 401 of FIG. 4A. In some embodiments, the first module 401 includes features generally similar to/identical to the first module 301 of FIGS. 3A-3D . Accordingly, like reference numbers refer to like components.

Referring to FIGS. 4A and 4B together, in the present embodiments, the first module 401 is in an unstacked configuration with reference to a second module (not shown). The first module 401 is configured to receive multiple charging docks, each of which is configured to receive multiple radio devices. The first module 401 includes a frame 410 with two vertical beams 412a, 412b, each of which has a top end 413a, 413b and a bottom end 414a, 414b. A horizontal beam 415 is configured to couple the vertical beams 412a, 412b via the top ends 413a, 413b. The first module 401 includes two foldable shelves 420a, 420b, each of which is coupled to the frame 410 via multiple support brackets 430. Multiple cable trays 440 are coupled to the frame 410, as are one or more outlet strips 403 and strip lights 404. In the present example, two outlet strips 403 are positioned/coupled to inward-facing surfaces of vertical beams 412a, 412b, and a strip light 404 is positioned/coupled to an inward-facing surface of horizontal beam 415.

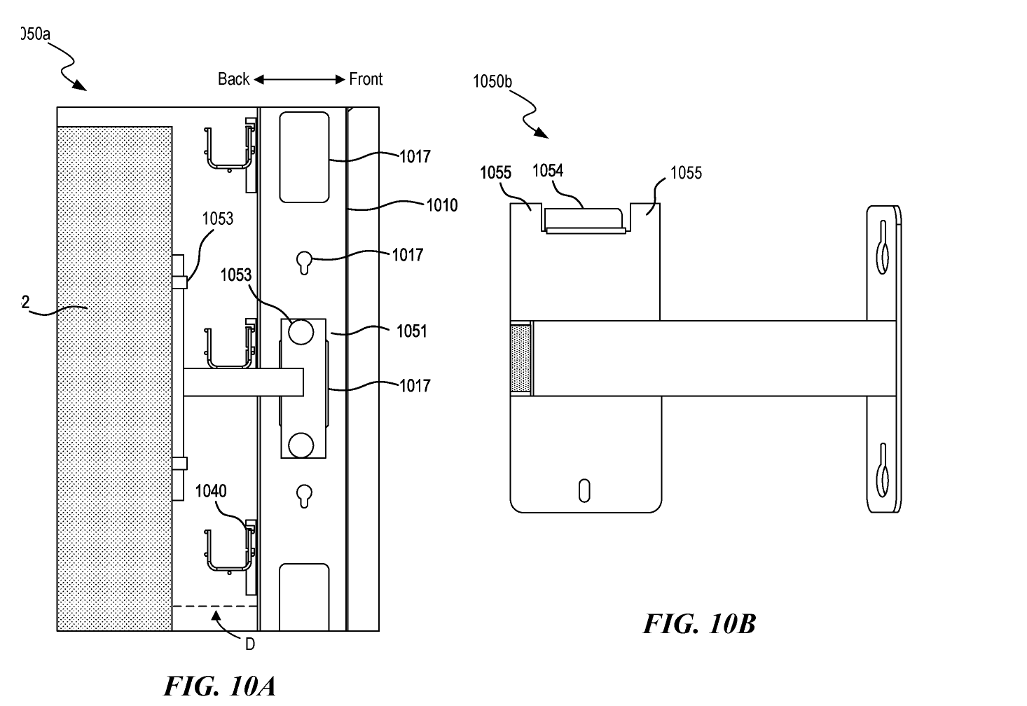

In the present embodiments, the first module 401 includes multiple mounting brackets 450 (discussed further with reference to FIGS. 10A-10B) configured to couple/attach the first module 401 to a vertical surface, such as a wall. The mounting brackets 450 are configured to couple to the frame 410 via one or more pre-positioned structures 417, which includes one or more groups of holes, notches, recesses, grooves, machined areas, etc. In some embodiments, the first module 401 is configured to couple to a rolling base (not shown) via the bottom ends 414a, 414b of the vertical beams 412a, 412b.

In some embodiments, the first module 401 is configured to be extendable to accommodate additional foldable shelves 420 (shown as a dashed line in FIG. 4A) and corresponding support components (e.g., additional frame 410 structures, support brackets 430, cable trays 440, pre-positioned structures 417, etc.).

FIG. 5A is a front view of a second module 502 of a charging rack system, in accordance with one or more embodiments. FIG. 5B is a side view of the second module 502 of FIG. 5A. In some embodiments, the second module 502 includes features generally similar to/identical to the second module 302 of FIGS. 3A-3D. Accordingly, like reference numbers refer to like components.

Referring to FIGS. 5A and 5B together, in the present embodiments, the second module 502 is in an unstacked configuration with reference to a first module (not shown, e.g., the first module 401 of FIGS. 4A-4B ). The second module 502 is configured to receive multiple charging docks, each of which is configured to receive multiple radio devices. The second module 502 includes a frame 510 with two vertical beams 512a, 512b, each of which has a top end 513a, 513b and a bottom end 514a, 514b. A horizontal beam 515 is configured to couple the vertical beams 512a, 512b via the top ends 513a, 513b. The second module 502 includes three foldable shelves 520a, 520b, 520c, each of which is coupled to the frame 510 via multiple support brackets 530. Multiple cable trays 540 are coupled to the frame 510, as are one or more outlet strips 503 and strip lights 504. In the present example, two strip lights 504 are positioned/coupled to inward-facing surfaces of vertical beams 512a, 512b, and an outlet strip 503 is positioned/coupled to an inward-facing surface of horizontal beam 515.

In the present embodiments, the second module 502 includes multiple mounting brackets 550 configured to couple/attach the second module 502 to a vertical surface, such as a wall. The mounting brackets 550 are configured to couple to the frame 510 via one or more pre-positioned structures 517, which includes one or more groups of holes, notches, recesses, grooves, machined areas, etc. In some embodiments, the second module 502 is configured to couple to a rolling base (not shown) via the bottom ends 514a, 514b of the vertical beams 512a, 512b.

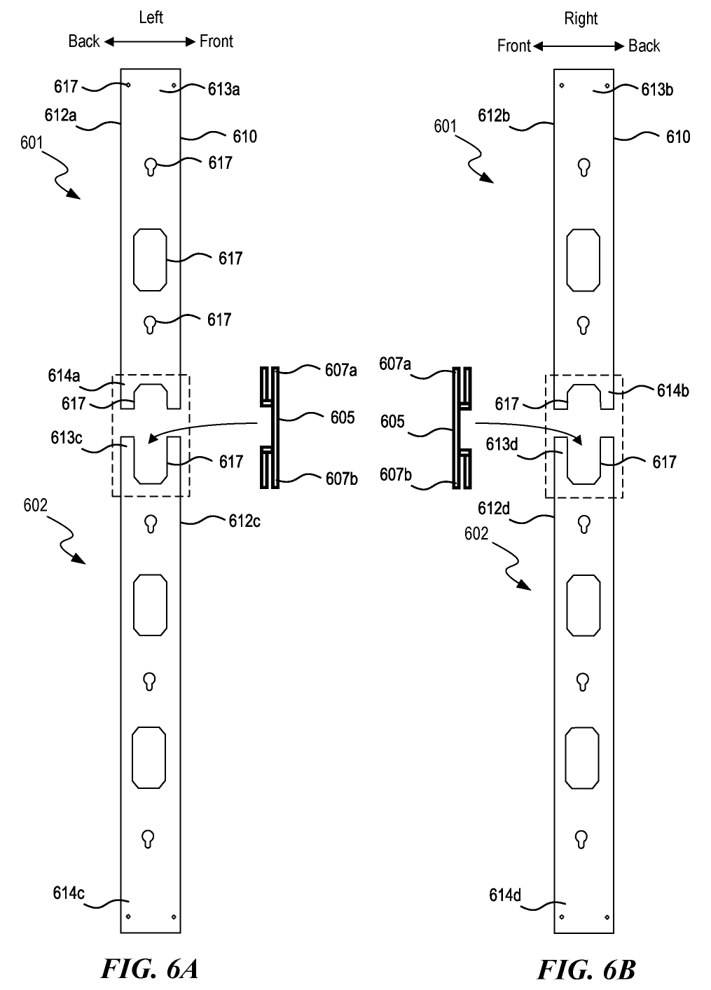

FIGS. 6A and 6B are side views of first and second vertical beams 612a, 612b of first and second modules 601, 602 with multiple connector brackets 605, in accordance with one or more embodiments. In some embodiments, the first and second modules 601, 602 include features generally similar to/identical to the first and second modules 301, 302 of FIGS. 3A-3D . Accordingly, like reference numbers refer to like components.

Referring to FIGS. 6A and 6B together, in the present embodiments, the first module 601 is configured to detachably couple to the second module 602 via multiple connector brackets 605 coupling the first module 601 to the second module 602 (shown as a dashed box on FIGS. 6A and 6B). These connector brackets 605 ensure a secure and stable connection between the modules 601, 602, enhancing the overall stability and functionality of the system. Each connector bracket 605 includes a first end 607a and a second end 607b. The first end 607a is configured to attach/couple to the bottom end (e.g., one of bottom end 614a and 614b) corresponding to one of the vertical beams 612a, 612b of the first module 601. In some embodiments, the first end 607a couples to the bottom end using one or more fixation elements (e.g., one or more bolts, screws, etc.) and via a first mating with one or more pre-positioned structures 617. The second end 607b is configured to attach/couple to the top end (e.g., one of top end 613c and 614d) corresponding to one of the vertical beams 612c, 612d of the second module 602. In some embodiments, the second end 607b couples to the top end using one or more fixation elements and via a second mating with one or more pre-positioned structures 617. Thus, the first and second modules 601, 602 are coupled together in a stacked configuration when the first ends 607a are coupled to the bottom ends of the vertical beams 612a and 612b of the first module 601, and the second ends 607b are coupled to the top ends of the vertical beams 612c and 612d of the second module 602.

FIGS. 7A-7C are various perspective views of a joint 724 connecting parts of a foldable shelf 720, in accordance with one or more embodiments. In some embodiments, the foldable shelf 720 includes features generally similar to/identical to the foldable shelves 320a–e of FIGS. 3A-3D. Accordingly, like reference numbers refer to like components.

Referring to FIGS. 7A-7C together, in the present embodiments, the joint mechanism 724 of the foldable shelves 720 provides robust support and facilitates bending of the shelf 720 in one or more preferred directions while preventing bending in one or more undesired directions when the shelf 720 is unfolded. In some embodiments, the joint 724 is a hinge coupled (e.g., welded) to the first and second sections 722, 723 of the foldable shelf 720, ensuring a durable and reliable connection. In some embodiments, the joint 724 couples to the first and second coupling elements 725, 726 of the first and second sections 722, 723. The hinge 724 features an axis of rotation A, allowing the shelf 720 to fold in a single direction when unfolded. When unfolded, the hinge 724 forms a flat surface 721 across the boundary between the first and second sections 722, 723, providing a continuous and stable platform for the charging docks.

The foldable shelf 720 includes a vertical section 727 that is perpendicular to the flat surface 721 of the foldable shelf 720. The vertical section 727 is configured to wall-in the multiple charging docks, ensuring they remain securely in place when positioned on the shelf 720. In some embodiments, each of the first and second sections 722, 723 includes a vertical section 727 configured with a projection 729 that extends orthogonally (e.g., perpendicularly) from both the vertical section 727 and the flat surface 721. In some embodiments, the projection 729 is manufactured (e.g., integral) with the vertical section 727 and/or flat surface 721. In some embodiments, the projection 729 includes a pre-positioned structure 717 (e.g., a hole, orifice, etc.) configured to receive a fixation element, such as a bolt or screw. When the projections 729 of the vertical section 727 and/or flat surfaces 721 are aligned, the foldable shelf 720 is substantially prevented from bending in a second direction about the axis of rotation A when the shelves are unfolded, providing additional stability and support.

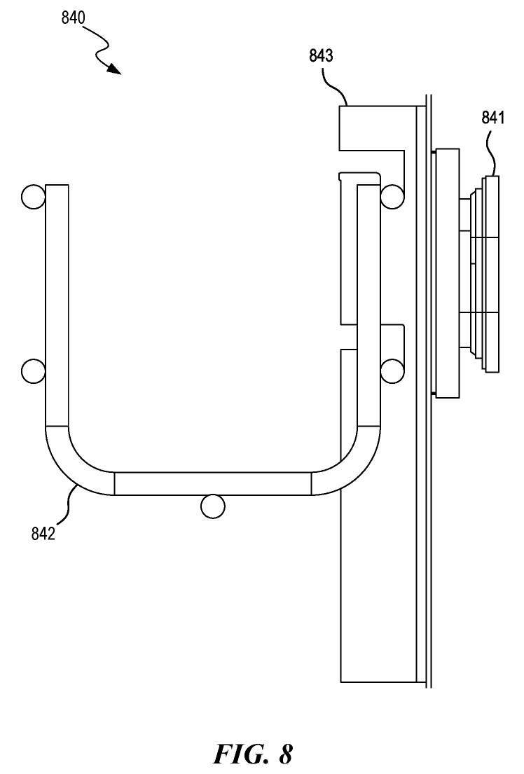

FIG. 8 is a side view of a cable tray 840, in accordance with one or more embodiments. In some embodiments, the cable tray 840 includes features generally similar to/identical to the cable tray 340 of FIGS. 3A-3D . Accordingly, like reference numbers refer to like components.

In some embodiments, the charging rack system includes one or more cable trays 840 designed to manage and organize the cabling associated with the charging docks and other equipment (e.g., outlet strips 303 and strip lights 304 described with reference to FIGS. 3A-3D). The cable trays 840 are generally shaped to form a basket structure 842 extending approximately the width of the frame (e.g., frame 310.) The cable trays 840 are configured to be secured to the frame by coupling multiple shaped connector elements 841 to one or more pre-positioned structures (e.g., structures 317), such as notches, in the first and second vertical beams of the frame. For example, the connector elements 841 are shaped to be fitted into a hole or notch in a surface of the frame. In some embodiments, each cable tray 840 has a length approximately equal to or less than the width of the frame, ensuring a compact and organized configuration. In some embodiments, the cable tray 840 includes an interface piece 843 configured to support the basket structure 842, and to provide one or more coupling points for the basket structure 842 to couple to the shaped connector element 841.

FIG. 9 is a perspective view of a support bracket 930, in accordance with one or more embodiments. In some embodiments, the support bracket 930 includes features generally similar to/identical to the support brackets 330 of FIGS. 3A-3D. Accordingly, like reference numbers refer to like components.

The support brackets 930 provide robust support for the foldable shelves (e.g., foldable shelves 320a–e and are designed to detachably couple to the first and second vertical beams (e.g., vertical beams 312a, 312b), ensuring stability and ease of assembly/disassembly. Each support bracket 930 has two arms 931, 932 that are coupled (e.g., welded) to form an acute angle. At least one of the two arms includes an attachment element 933 (e.g., the shaped connector element 841 of FIG. 8) to detachably couple to the first or second vertical beams via multiple pre-positioned structures (e.g., notches, holes, grooves, etc.) in a surface of the first or second vertical beams. of the brackets, providing robust support for the foldable shelves. In some embodiments, each support bracket 930 has two arms 931, 932 that are adjoined via one or more fasteners (e.g., screws, bolts, etc.) to form an acute angle.

FIG. 10A is a side view of a mounting bracket 1050a on a module (e.g., first module 401 of FIGS. 4A-4B), in accordance with one or more embodiments. In some embodiments, the mounting bracket 1050a includes features generally similar to/identical to the mounting brackets 450 of FIGS. 4A-4B. Accordingly, like reference numbers refer to like components.

In some embodiments, a module (e.g., first module 401, second module 502, etc.) includes multiple mounting brackets 1050a designed to securely attach the module to a vertical surface 1052 (e.g., a wall). These mounting brackets 1050a ensure that the module(s) remains stable and securely fastened, without taking up floor space. Each mounting bracket 1050a is configured to couple to a surface 1051 of a frame 1010 of the module. In some embodiments, the surface 1051 is an outward-facing (with respect to a center point of the module) surface 1051. In some embodiments, the outward-facing surface 1051 is configured to be perpendicular to the wall 1052. The mounting brackets 1050a are configured to couple to the outward-facing surface 1051 of the frame 1010 via one or more fixation elements 1053 (e.g., bolts, screws, etc.) coupling to one or more pre-positioned structures 1017 (e.g., any of the pre-positioned structures discussed in FIGS. 3A-3D). The mounting brackets 1050a are further configured to couple to the wall 1052 via one or more fastening elements 1053.

In some embodiments, the mounting brackets 1050a are configured to provide a stand-off distance D from the wall 1052 that is greater than the width of a cable tray 1040 and/or column of cable trays 1040 secured to the frame 1010. The stand-off distance D ensures that there is sufficient space between the wall 1052 and the frame to accommodate the cable trays 1040 and any associated cabling. This enhances the overall organization and functionality of the charging rack system, ensuring that cables remain neatly managed and accessible.

FIG. 10B is a perspective view of a mounting bracket 1050b, in accordance with one or more embodiments. In some embodiments, the mounting bracket 1050b includes features generally similar to/identical to the mounting brackets 1050a of FIG. 10A. Accordingly, like reference numbers refer to like components. In the present embodiment, one of the principal differences from mounting bracket 1050a is that mounting bracket 1050b includes a clip feature 1054 configured to slide into a pre-positioned structure 1017 such that a first end 1055 of the mounting bracket 1050b straddles the edge/rim of the pre-positioned structure 1017. This provides stabilization support for the mounting bracket 1050b while minimizing the number of fastening elements 1053 needed to secure the mounting bracket 1050b to the frame 1010.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. It will be appreciated that the same thing can be said in more than one way.

Consequently, alternative language and synonyms are used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

I/We claim:

1. A charging rack system configured for housing multiple charging docks for mass charging of wireless smart radio devices, the charging rack system comprising:
a first module including:
a first rigid frame including:
a first vertical beam having a top end and a bottom end opposite the top end;
a second vertical beam having a top end and a bottom end opposite the top end; and
a horizontal beam connecting the top ends of the first and second vertical beams;
one or more foldable shelves each including:
a first section having a surface configured to attach multiple charging docks to the foldable shelf, the first section including a first coupling element;
a second section configured to attach multiple charging docks to the foldable shelf, the second section including a second coupling element;
a joint that couples the first and second coupling elements and has an axis of rotation about which the shelf is foldable in only a single direction and, when unfolded, forms a flat surface across a boundary that adjoins the first and second sections; and
a vertical section that is perpendicular to the flat surface of the foldable shelf and configured to wall-in the multiple charging docks on the shelf; and
multiple support brackets configured to detachably couple to the first and second vertical beams as support structures for the one or more foldable shelves,
wherein the first module is stackable to a second module.

2. The system of claim 1, wherein the height relative to the ground of the second module is different than the height relative to the ground of the first module, and wherein the second module is a base to the first module when the first and second modules are stacked.

3. The system of claim 2, wherein the first module includes two of the one or more foldable shelves, the foldable shelves being equally spaced vertically.

4. The system of claim 2, wherein the second module includes three of the one or more foldable shelves, the foldable shelves being equally spaced vertically.

5. The system of claim 1, wherein each of the first and second vertical beams further includes multiple pre-positioned structures between the top and bottom ends of each of the vertical beams, wherein the pre-positioned structures are configured to accommodate detachably coupling the first module to the second module when the first and second modules are stacked.

6. The system of claim 5, wherein the first module is configured to detachably couple to the second module via multiple connector brackets, each of the connector brackets including:
a first end configured to attach to one of the vertical beams of the first module via a first mating with one of the pre-positioned structures in the vertical beam of the first module; and
a second end opposite the first end configured to attach to one of the vertical beams of the second module via a second mating with one of the pre-positioned structures in the vertical beam of the second module.

7. The system of claim 1, wherein each of the one or more foldable shelves has an unfolded length greater than the width of the first rigid frame, and wherein each of the first and second sections is configured to attach at least two charging docks.

8. The system of claim 1, further including one or more cable trays, each of the one or more cable trays configured to be secured to the first rigid frame via one or more notches in the first and second vertical beams, and wherein each of the one or more cable trays has a length approximately equal to or less than the width of the first rigid frame.

9. The system of claim 1, wherein the first rigid frame includes one or more surfaces configured to simultaneously couple each of at least one outlet strip and at least one magnetic strip light to the first rigid frame, the one or more surfaces comprising:
one or more inward-facing surfaces of the vertical and horizontal beams with respect to a center point of the first rigid frame; and
one or more outward-facing surfaces of the vertical and horizontal beams with respect to the center point of the first rigid frame.

10. The system of claim 9, wherein the at least one outlet strip includes multiple outlets, and wherein the outlet strip is configured to couple to one or more surfaces of the first rigid frame via one or more pre-positioned structures in the first rigid frame.

11. The system of claim 9, wherein the at least one magnetic strip light is configured to be:
positioned on the one or more inward-facing surfaces of the vertical and horizontal beams when the at least one outlet strip is positioned on the one or more outward-facing surfaces of vertical and horizontal beams;
positioned on the inward-facing surface of the horizontal beam when the at least one outlet strip is positioned on the one or more inward-facing surfaces of the vertical beams; and
positioned on the one or more inward-facing surfaces of the vertical beams when the one or more outlet strips are positioned on the inward-facing surface of the horizontal beam.

12. The system of claim 1, wherein the first module further includes a rolling base configured to detachably couple to the bottom ends of the first and second vertical beams, wherein the rolling base includes multiple casters and at least one irregularly-shaped surface.

13. The system of claim 1, wherein the first module further includes multiple wall brackets configured to attach the first module to a wall, wherein each wall bracket is configured to couple to a first outward-facing surface of the first rigid frame, the first outward-facing surface being perpendicular to the wall, and wherein the first rigid frame has a stand-off distance from the wall that is greater than the width of a cable tray secured to a second outward-facing surface of the first rigid frame.

14. The system of claim 1, wherein each of the first and second sections of the one or more foldable shelves further include multiple elongated slots configured to attach the charging docks to the first and second sections, the multiple elongated slots spanning the length of each of the first and second sections and spaced such that there is a first distance between a first slot and a second slot, followed by a second distance between the second slot and a third slot, followed by a third distance between the third slot and a fourth slot, wherein the first and third distances are approximately equal and the second distance is less than the first distance.

15. The system of claim 1, wherein the joint is a hinge welded to the first and second sections of the foldable shelves, wherein the vertical section that is perpendicular to the flat surface of the foldable shelves is configured to substantially prevent the foldable shelves from bending in a second direction about the axis of rotation when the foldable shelves are unfolded.

16. The system of claim 1, wherein each support bracket has two arms that are welded to form an acute angle, wherein at least one of the two arms includes an attachment element to detachably couple to the first or second vertical beams via multiple notches in a surface of the first or second vertical beams.

17. The system of claim 1, wherein each support bracket has two arms that are adjoined to form an acute angle via multiple fasteners, wherein at least one of the two arms includes an attachment element to detachably couple to the first or second vertical beams via multiple notches in a surface of the first or second vertical beams.

18. The system of claim 1, wherein the height of the vertical section that is perpendicular to the flat surface of the foldable shelf is greater than the height of the charging docks.

19. A charging rack system comprising:
a rigid frame including:
multiple vertical beams, each vertical beam having a top end and a bottom end opposite the top end; and
one or more horizontal beams connecting the top ends of the multiple vertical beams;
one or more foldable shelves each including:
a first flat section configured to attach multiple charging docks to the foldable shelf, the first flat section including a first coupling element;
a second flat section configured to attach multiple charging docks to the foldable shelf, the second section including a second coupling element;
a joint that couples the first and second coupling elements such that the foldable shelve is foldable in only a single direction and, when unfolded, forms a flat surface that adjoins the first and second sections; and
a vertical section that is perpendicular to the flat surface of the foldable shelf and configured to wall-in the multiple charging docks on the shelf; and
multiple support brackets configured to detachably couple to the first and second vertical beams,
wherein the charging rack system is stackable to additional charging rack systems.

20. A first charging module including:
a rigid outer support structure including:
a first vertical bar having a top end and a bottom end opposite the top end;
a second vertical bar having a top end and a bottom end opposite the top end; and
a horizontal bar connecting the top ends of the first and second vertical bars;
multiple foldable shelves each including:
a first section having a surface configured to attach multiple charging docks to the foldable shelf, the first section including a first coupling element;
a second section configured to attach multiple charging docks to the foldable shelf, the second section including a second coupling element;
a joint that couples the first and second coupling elements and has an axis of rotation about which the shelf is foldable in only a single direction and, when unfolded, forms a flat surface across a boundary that adjoins the first and second sections; and
a vertical section that is perpendicular to the flat surface of the foldable shelf and configured to wall-in the multiple charging docks on the shelf; and
multiple support brackets configured to detachably couple to the first and second vertical bars as support structures for the multiple foldable shelves,
wherein the first charging module is stackable to a second module.
